(19) United States
(12) Patent Application Publication
(10) Pub. No.: US 2018/0126518 A1
(43) Pub. Date: May 10, 2018

(54) CROSS WRENCH

(71) Applicant: Fu-Yi Chan, Taichung (TW)

(72) Inventor: Fu-Yi Chan, Taichung (TW)

(21) Appl. No.: 15/346,731

(22) Filed: Nov. 9, 2016

(51) Int. Cl. B25B 13/00; B25G 1/00

(52) U.S. Cl. CPC B25B 13/005; B25G 1/005

(57) ABSTRACT

A cross wrench includes a first part having a passage, a first receiving recess, a first connection portion, a second receiving recess and a second connection portion. A second part unit includes a second part which is perpendicular to the first part. The second part includes a third connection portion, a fourth connection portion and multiple first engaging portions. A third part unit is connected to the first part. The first part, the second part unit and the third part unit are connected to form a cross wrench. The third part unit includes a third part which has two sixth connection portions which are selectively connected to the first connection portion of the first part.

### BACKGROUND OF THE INVENTION

### 1. Fields of the Invention

The present invention relates to a hand tool, and more particularly, to a cross wrench which includes multiple part units assembled together to perform multiple tasks.

### 2. Descriptions of Related Art

The conventional detachable cross wrench is disclosed in U.S. Pat. No. 7,228,766 and comprises a primary bar having one polygonal portion at one end thereof, and a thickening middle portion is formed at the center thereof. A turning handle is mounted on the other end of the primary bar. A lateral through hole is formed in the thickening middle portion for insertion of a secondary bar to create a cross type wrench. A longitudinal hole communicates with the lateral through hole for receiving a compression knob in cooperation with a resilient element and a positioning element. The compression knob has a slim portion in the middle thereof and an engaging portion at the lower portion thereof. A secondary bar has a polygonal portion at one end thereof and a handle portion at the other end thereof. The secondary bar further has at least one engaging groove, wherein the primary bar and the second bar are fixed in relation to one another through the engaging portion selectively engaging the engaging grooves in the second bar.

However, there are only two polygonal portions available for being connected with other bits or the like. Besides, the secondary bar has only two engaging grooves so that the hand tool can only be used as disclosed in FIGS. 2 and 3 of the U.S. Pat. No. 7,228,766. When using the hand tool as disclosed in FIG. 3, the secondary bar is used as an arm of force, and the secondary bar is offset from the axis of the primary bar, this affects the operational feature.

The present invention intends to provide a hand tool with three part unit which are selectively connected to each other and the shortcomings mentioned above can be eliminated.

### SUMMARY OF THE INVENTION

The present invention relates to a cross wrench which comprises a first part having a passage, a first receiving recess, a first connection portion, a second receiving recess and a second connection portion. A second part unit includes a second part which is perpendicular to the first part. The second part includes a third connection portion, a fourth connection portion and multiple first engaging portions. A third part unit is connected to the first part. The first part, the second part unit and the third part unit are connected to form a cross wrench. The third part unit includes a third part which has two sixth connection portions which are selectively connected to the first connection portion of the first part.

The present invention is to provide a cross wrench which includes a first part with a second connection portion, a second part with third and fourth connection portions, a third part with two sixth connection portions. There are four rectangular connection portions available for the cross wrench so as to be connected with different sockets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the cross wrench of the present invention;

FIG. 2 shows the second part of the cross wrench of the present invention;

FIG. 3 is an enlarged view of the circled portion “A” in FIG. 2;

FIG. 4 is a perspective view to show the cross wrench of the present invention;

FIG. 5 is a top view of the cross wrench of the present invention;

FIG. 6 is a cross sectional view, taken along line 6-6 in FIG. 5;

FIG. 7 is a front view of the cross wrench of the present invention;

FIG. 8 is a cross sectional view, taken along line 8-8 in FIG. 7;

FIG. 9 shows another operational status at the portion disclosed in FIG. 8;

FIG. 10 is a top view to show the second operational status of the cross wrench of the present invention;

FIG. 11 is a cross sectional view, taken along line 11-11 in FIG. 10;

FIG. 12 shows the third operational status of the cross wrench of the present invention;

FIG. 13 shows the fourth operational status of the cross wrench of the present invention;

FIG. 14 is a cross sectional view to show the second embodiment of the cross wrench of the present invention;

FIG. 15 is a cross sectional view to show the third embodiment of the cross wrench of the present invention;

FIG. 16 is an exploded view of the fourth embodiment of the cross wrench of the present invention; and

FIG. 17 is a perspective view of the fifth embodiment of the cross wrench of the present invention.

### DETAILED DESCRIPTION OF THE PREFERRED EMBODIMENT

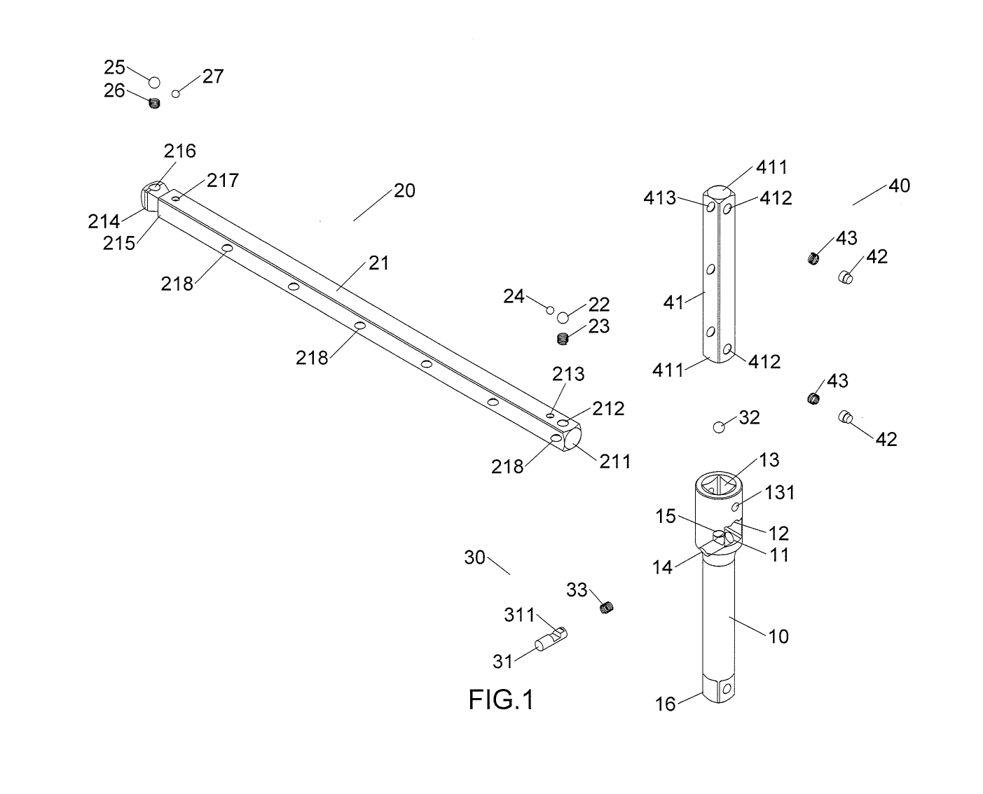

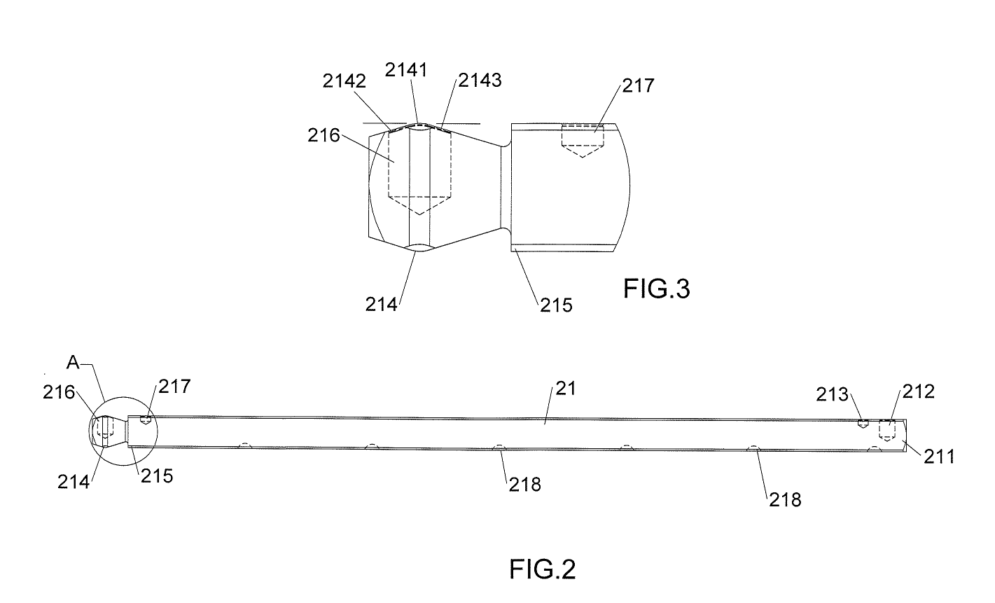

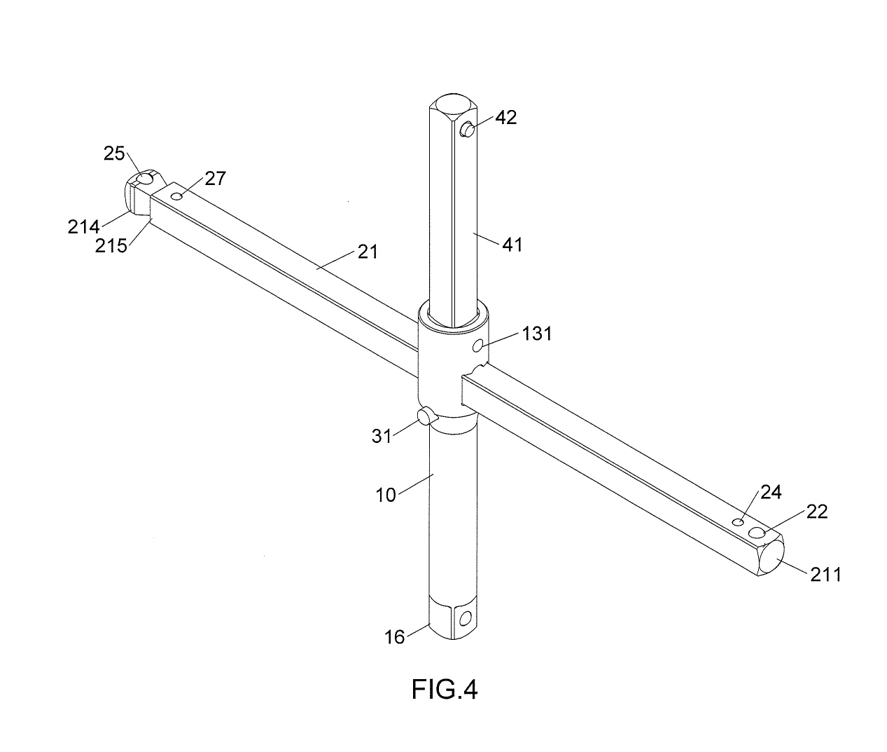

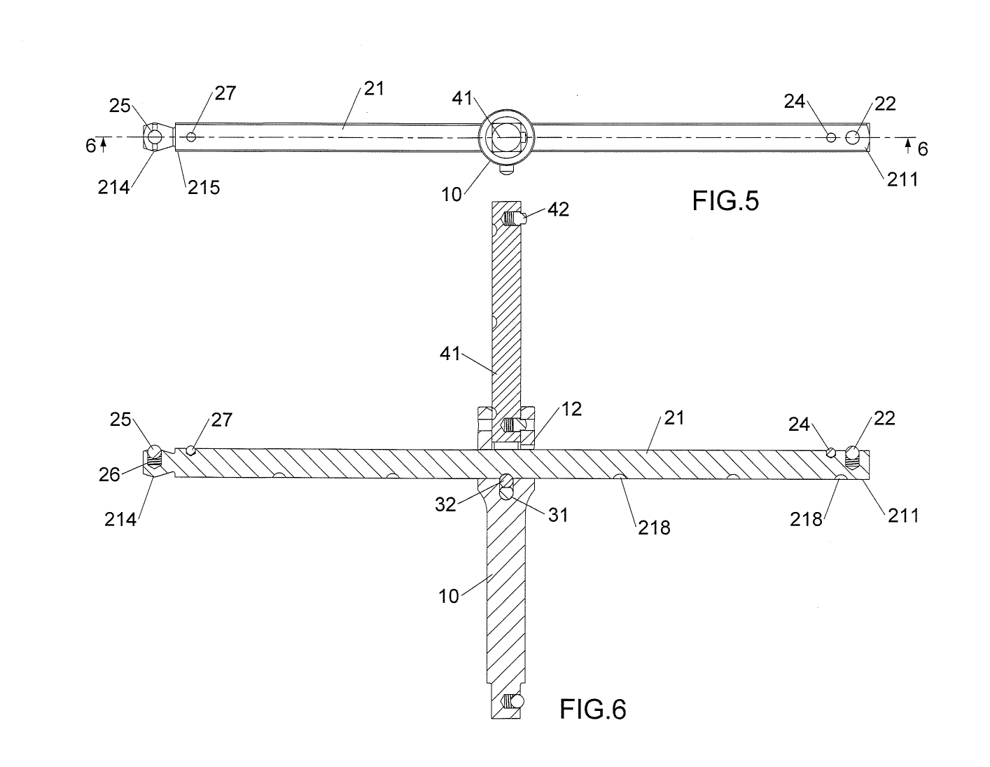

Referring to FIGS. 1 to 6, the cross wrench of the present invention comprises a first part 10, a second part unit 20, a push unit 30 and a third part unit 40.

The first part 10 has a rectangular passage 11 defined radially through the first end thereof. A first receiving recess 12 is defined in one inside of the passage 11 and does not extend through the first end of the first part 10. The center of the first receiving recess 12 is located within the passage 11. The first receiving recess 12 is a circular groove. A rectangular first connection portion 13 is defined in the first end of the first part 10, and the axis of the first connection portion 13 is perpendicular to the axis of the passage 11. The first connection portion 13 communicates with the passage 11. The passage 11 and the first connection portion 13 have the same shape and size. A second receiving recess 131 is defined radially through the first end of the first part 10 and communicates with the first connection portion 13. The axis of the first connection portion 13 is perpendicular to the axis of the second receiving recess 131 which is a hole. The axis of the second receiving recess 131 is parallel to the axis of the first receiving recess 12. A reception hole 14 is defined radially in the first end of the first part 10. The passage 11 has an engaging recess 15 which is a circular recess and communicates with the passage 11 and the reception hole 14. A rectangular second connection portion 16 is formed on the second end of the first part 10 so as to be connected with a socket 82. The first part 10 is a rod. The passage 11, the first connection portion 13 and the second connection portion 16 have the same specification.

The second part unit 20 is connected to the first part 10 and includes a second part 21, a first bead 22, a first resilient member 23, a second bead 24, a third bead 25, a third resilient member 26 and a fourth bead 27. The second part 21 is a rod and has a rectangular cross section that is allowed to extend through the passage 11 of the first part 10. The second part 21 movably extends through the passage 11 and is perpendicular to the first part 10. The second part 21 has a third connection portion 211 formed on the first end thereof and the third connection portion 211 is a rectangular protrusion which has the same specification as the first connection portion 13 and the second connection portion 16. The third connection portion 211 has a first recess 212 defined in one side of the second part 21. The first recess 212 is a circular recess and located corresponding to the first receiving recess 12 of the first part 10. The diameter of the first recess 212 is the same as the diameter of the engaging recess 15. A second recess 213 is defined next to the first recess 212 which is located closer to the third connection portion 211 than the second recess 213. The second recess 213 is a circular recess. The diameter of the second recess 213 is smaller than the diameter of the first recess 212. A fourth connection portion 214 is formed on the second end of the second part 21 and is a rectangular protrusion. The fourth connection portion 214 has the same specification as that of the second and third connection portions 16, 211. The fourth connection portion 214 includes a first face 2141, a second face 2142 and a third face 2143. The first face 2141 is located between the second and third faces 2142, 2143. The second and third faces 2142, 2143 are located symmetrically relative to the first face 2141. The first face 2141 is a curved face, and the second and third faces 2142, 2143 each are an inclined face. The third recess 216 is located corresponding to the first face 2141.

A fifth connection portion 215 is formed between the second end of the second part 21 and the fourth connection portion 214. The fifth connection portion 215 has a rectangular cross section and has the same specification as the fourth connection portion 214. The fourth connection portion 214 has a third recess 216 which is a circular recess. The diameter of the third recess 216 is the same as diameter of the first recess 212. The fifth connection portion 215 has a fourth recess 217 which is a circular recess. The diameter of the fourth recess 217 is the same as the diameter of the second recess 213. The fourth recess 217, the third recess 216, the second recess 213 and the first recess 212 are located on the same side of the second part 21. The second part 21 has multiple first engaging portions 218 defined in another side thereof and each first engaging portions 218 is a circular recess. One of the first engaging portions 218 is located at the middle of the second part 21. When the second part 21 moves, the engaging recess 15 of the first part 10 is located corresponding to one of the first engaging portions 218.

The first bead 22 and the first resilient member 23 are received in the first recess 212 of the second part 21. The first resilient member 23 is biased between the inner end of the first recess 212 and the first bead 22. The first bead 22 is received in the first receiving recess 12 so as to be hidden in the first part 10. The third connection portion 211 is located in the first part 10.

The second bead 24 is located in the second recess 213. The diameter of the second bead 24 is smaller than the diameter of the first bead 22. The second bead 24 restricts the second part 21 from disengaging from the passage 11. The third bead 25 and the third resilient member 26 are received in the third recess 216 of the second part 21. The third resilient member 26 is biased between the inner end of the third recess 216 and the third bead 25. The fourth bead 27 is located in the fourth recess 217. The diameter of the fourth bead 27 is the same as the diameter of the second bead 24. The fourth bead 27 restricts the second part 21 from disengaging from the passage 11. The push unit 30 is connected to the first part 10 and has a rod 31, a fifth bead 32 and a fifth resilient member 33. The rod 31 is movably located in the reception hole 14 and one end of the rod 31 protrudes from the reception hole 14. A notch 311 is defined in the lateral side of one end of the rod 31 and includes a first position and a second position. The engaging recess 15 is located corresponding to the first and second positions of the notch 311 when the rod 31 moves. The fifth bead 32 is located in the engaging recess 15 and the first position of the notch 311. The fifth bead 32 protrudes from the engaging recess 15 and contacts against the first engaging portion 218 of the second part 21 to position the second part 21. The fifth resilient member 33 is a spring and located in the reception hole 14 of the first part 10. The fifth resilient member 33 is biased between the reception hole 14 and the rod 31.

The third part unit 40 is connected to the first part 10. The first part 10, the second part unit 20 and the third part unit 40 are arranged to be a cross-shaped combination. The third part unit 40 has a third part 41, two engaging members 42 and two sixth resilient members 43. The third part 41 is a rod and has a rectangular cross section which is the same as the first connection portion 13 of the first part 10. The third part 41 has a sixth connection portion 411 formed on each of two ends thereof. The sixth connection portions 411 are able to be engaged with the first connection portion 13 of the first part 10. The sixth connection portion 411 has the same specification as the second, third, fourth and fifth connection portions 16, 211, 214, 215. The third part 41 has two sixth recesses 412 defined in one side thereof and each sixth recess 412 is a circular recess. The two sixth recesses 412 is alternatively located corresponding to the second receiving recess 131 of the first part 10. The third part 41 has multiple second engaging portions 413 formed in another side thereof. One of the second engaging portions 413 is located at the middle of the third part 41. Each second engaging portion 413 is a circular recess.

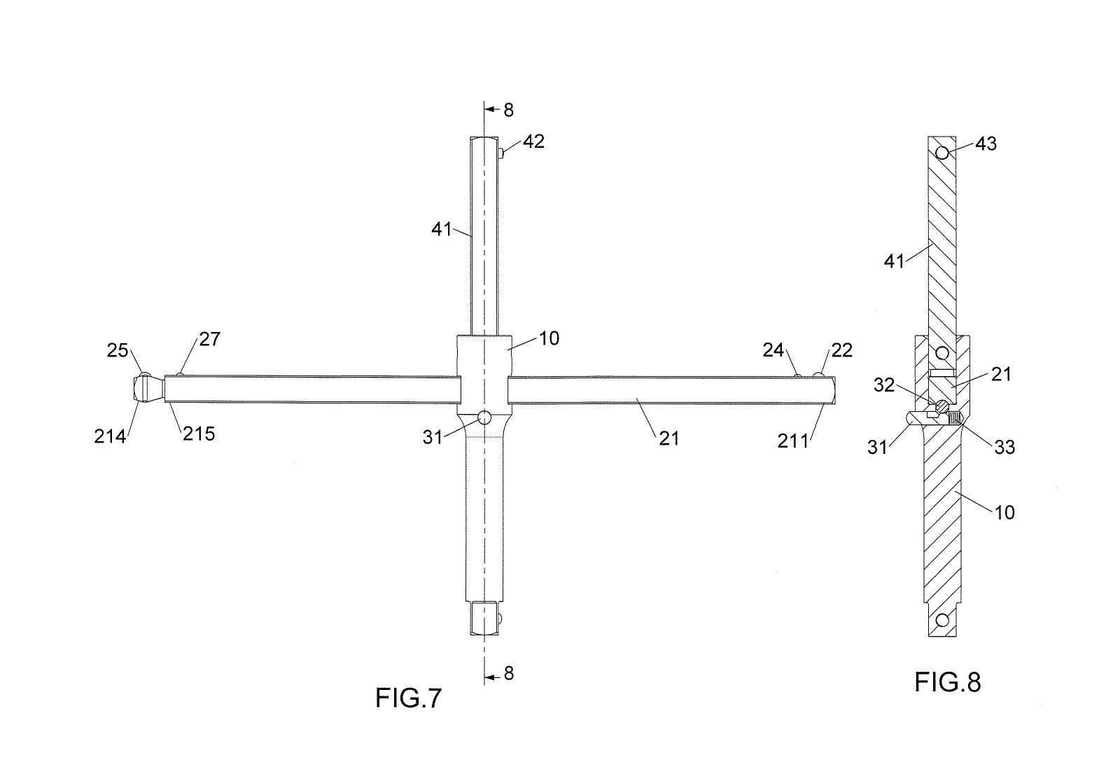

The engaging members 42 each are a stepped cylindrical part and respectively located in the sixth recesses 412 and partially protrude from the sixth recesses 412. The sixth resilient members 43 are respectively located in the sixth recesses 412 of the third part 41 and each are biased between the sixth recess 412 and the engaging member 42 corresponding thereto which contacts the second receiving recess 131 so that the sixth connection portion 411 of the third part 41 is engaged with the first connection portion 13. The sixth resilient members 43 each are a spring. As shown in FIGS. 7 to 9, when the rod 31 is pushed, the rod 31 moves in the reception hole 14 and contacts the fifth resilient member 33, the fifth bead 32 is received in the second position of the notch 311 so that the fifth bead 32 is disengaged from the first engaging portion 218 and merged in the engaging recess 15. The second part 21 is not restricted by the push unit 30 and movable relative to the first part 10 so that the second part 21 is adjusted.

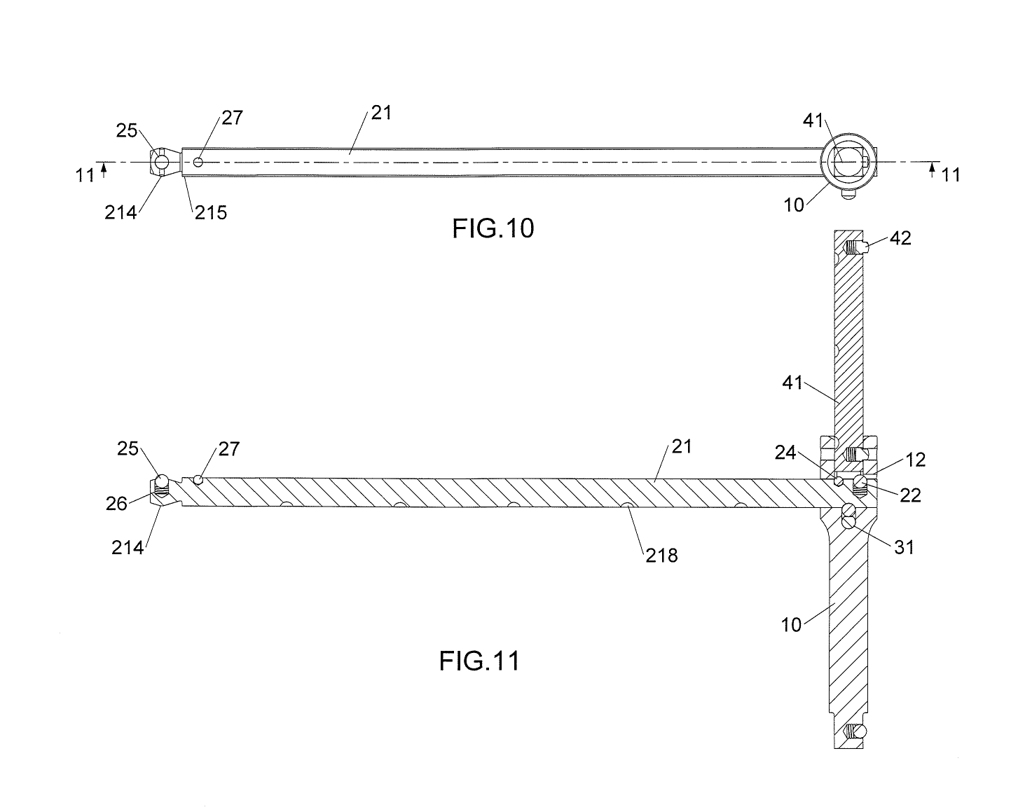

As shown in FIGS. 10 and 11, the second part 21 is movable left and right relative to the first part 10, the first bead 22 passes through the first receiving recess 12 to merge the third connection portion 211 in the passage 11 completely. The second bead 24 partially protrudes beyond the second recess 213 and contacts the inside of the first connection portion 13 so that the second part 21 is restricted by the second bead 24 and does not separated from the first part 10. The fifth bead 32 contacts the first engaging portion 218, and the first and second part 21 is combined as an L-shaped combination.

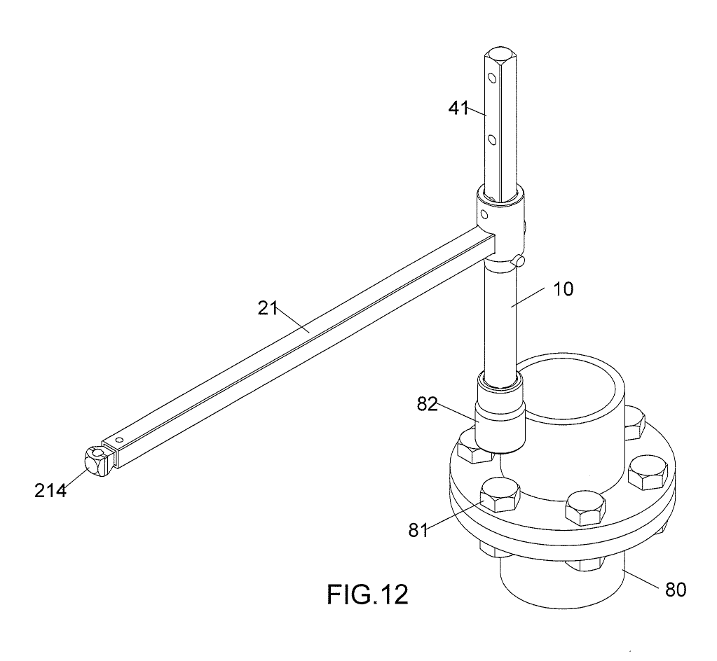

As shown in FIG. 12, when connecting two tubes 80 together, each tube 80 has a flange to which multiple bolts 81 are connected. The first part 10 is connected with a socket 82 to rotate the bolts 81 to prevent the third connection portion 211 from hitting the tubes 80. Therefore, the cross wrench can be rotate the bolts 81.

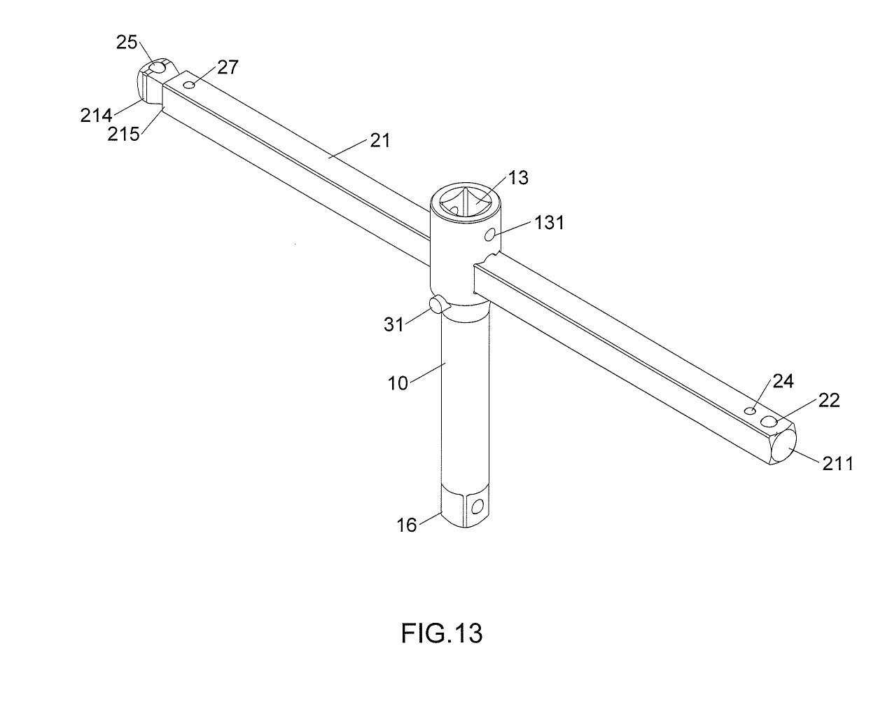

As shown in FIG. 13, the third part unit 40 can be separated from the first connection portion 13 and the second receiving recess 131. The first part 10 and the second part unit 20 are connected to be a single hand tool.

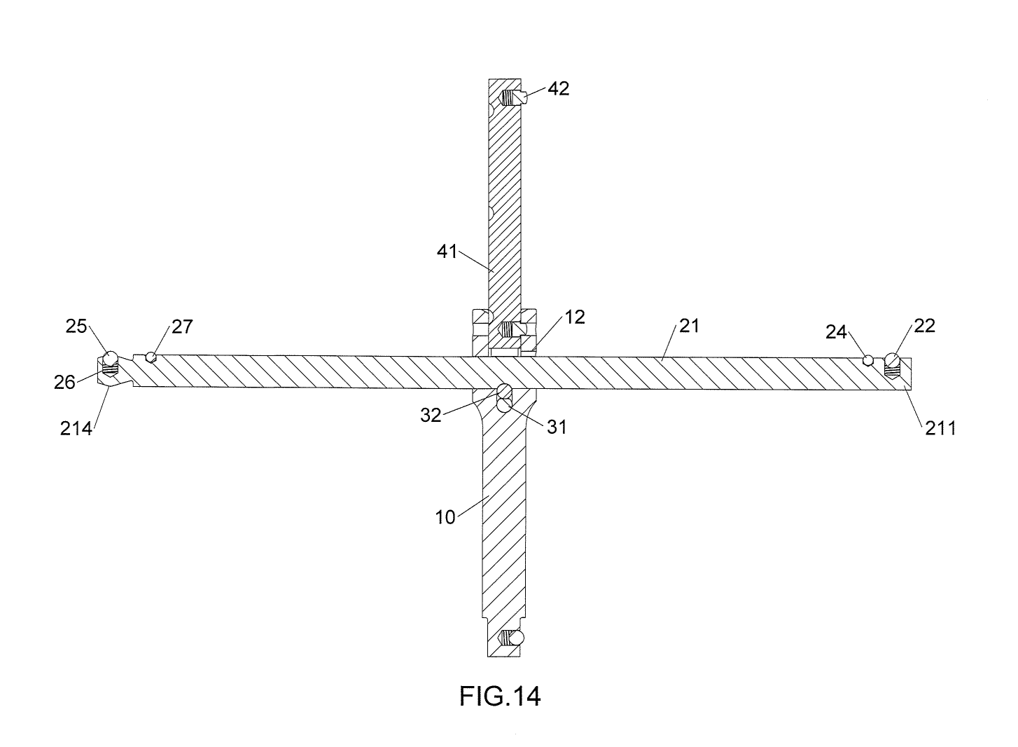

As shown in FIG. 14, the second part 21 has only one first engaging portion 218 which is located at the middle portion of the second part 21.

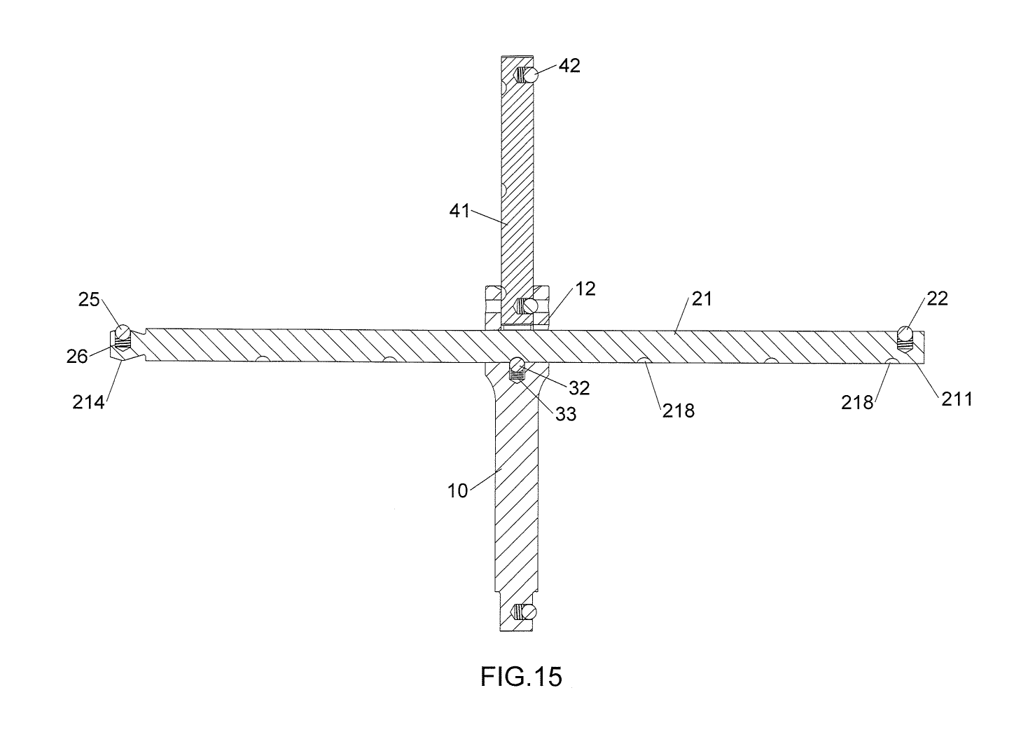

As shown in FIG. 15, the first part 10 does not have the reception hole 14, only the engaging recess 15 is available. The push unit 30 does not have the rod 31. The fifth bead 32 and the fifth resilient member 33 are located in the engaging recess 15 of the first part 10. The fifth bead 32 is biased by the fifth resilient member 33 and contacts the first engaging portion 218. The second part 21 does not have the second recess 213 and the fourth recess 217, that is to say, there is no second bead 24 and the fourth bead 27. The second part 41 is not restricted by the second and fourth beads 24, 27 and can be separated from the first part 10.

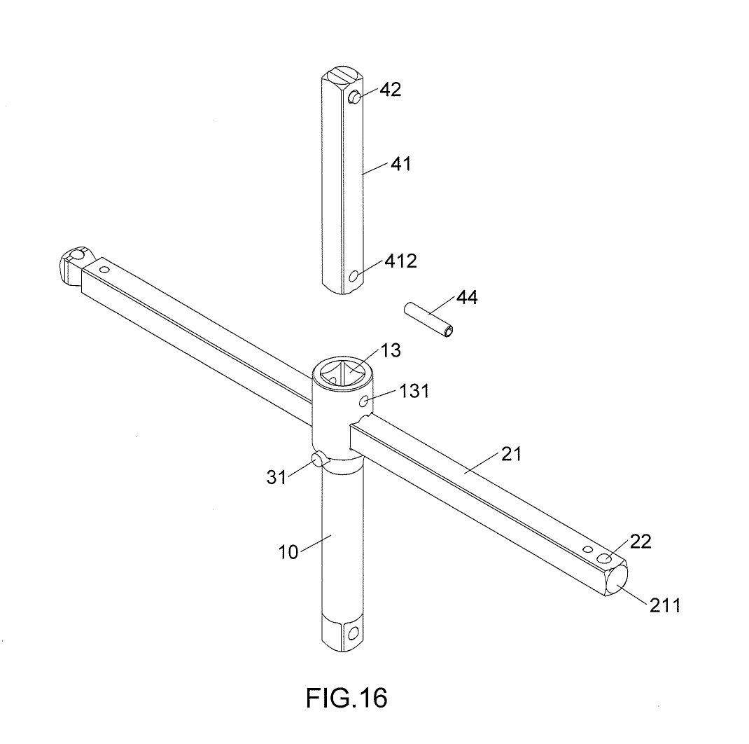

As shown in FIG. 16, the third part unit 40 includes one engaging member 42 and one sixth resilient member 43. A pin 44 extends through the second receiving recess 131 of the first part 10 and the sixth recess 412 of the third part 41 so that the third part 41 is engaged with the first connection portion 13. The pin 44 restricts the third part 41 from disengaging from the first connection portion 13.

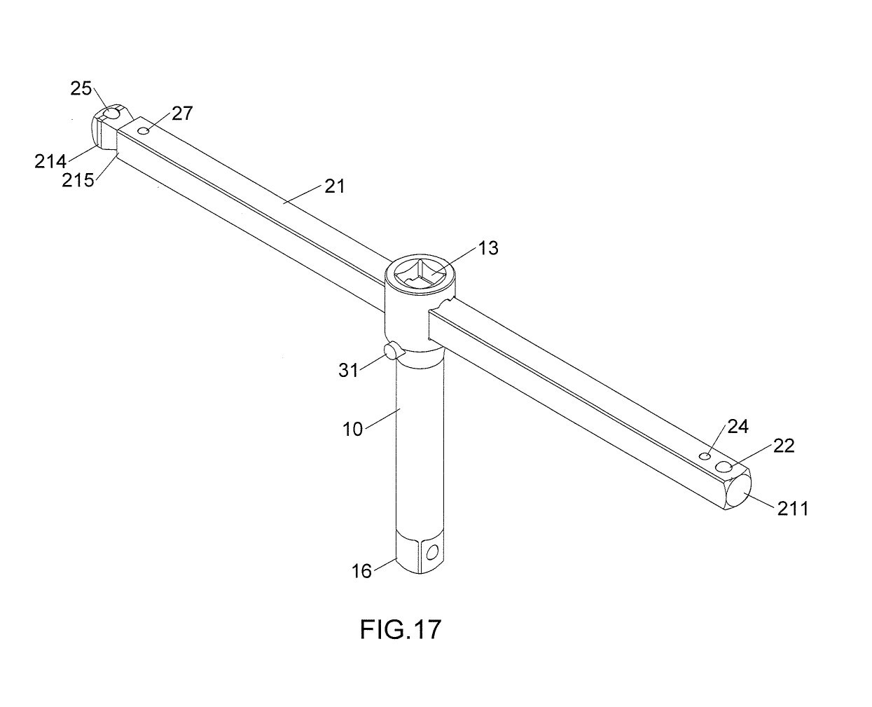

As shown in FIG. 17, the first part 10 does not have the second receiving recess 131, and there is no third part unit 30 is available for the cross wrench.

The present invention has multiple advantages which are that the second part 21 has a third and fourth connection portions 211, 214, and both of which are rectangular protrusions of same specification. In other words, the second part 21 can be connected to two hand tools that have the same specification. When the second part 21 is rotated, the first part 10 is used as the arm of force to rotate the second part 21.

The first part 10 has the second connection portion 16, and the third part 41 has the sixth connection portion 411. The second and sixth connection portions 16, 411 are rectangular protrusions. The cross wrench has the second, third, fourth and the sixth connection portions 16, 211, 214 and 411 rectangular connection portions so as to be connected with four sockets that have the same specification.

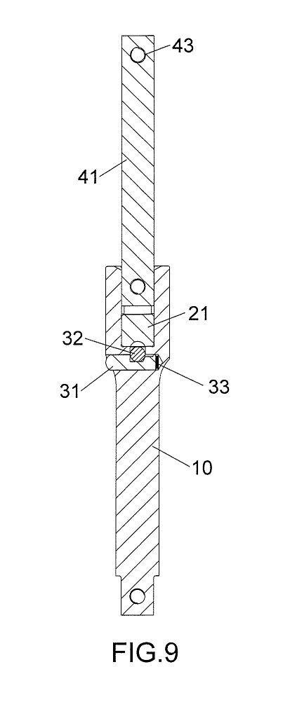

As shown in FIGS. 8 and 9, when the rod 31 is pushed, the rod 31 moves in the reception hole 14 and contacts the fifth resilient member 33 which is compressed and received in the second position of the notch 311. The fifth bead 32 is disengaged from the first engaging portion 218 and merged in the engaging recess 15. The second part 21 is not restricted by the push unit 30 and movable relative to the first part 10.

As shown in FIGS. 10 and 11, the first bead 22 passes through the first receiving recess 12 to merge the third connection portion 211 in the passage 11 completely. The second bead 24 received in the fourth recess 217 partially protrudes beyond the fourth recess 217 and contacts the inside of the first connection portion 13 so that the second part 21 is restricted by the second bead 24 and does not separated from the first part 10. The fifth bead 32 contacts the first engaging portion 218, and the first and second parts 10, 21 are combined as an L-shaped combination. The third connection portion 211 is merged in the passage 11. When the cross wrench is rotated, the third connection portion 211 does not hit other objects.

As shown in FIG. 13, the third part unit 40 can be separated from the first connection portion 13 and the second receiving recess 131. The first and second parts 10, 21 are combined to be used as a single hand tool.

While we have shown and described the embodiment in accordance with the present invention, it should be clear to those skilled in the art that further embodiments may be made without departing from the scope of the present invention.

What is claimed is:

1. A cross wrench comprising:
a first part having a passage defined radially through a first end thereof, the passage being a rectangular passage, a first receiving recess 12 defined in one inside of the passage and being not extending through the first end of the first part, a center of the first receiving recess located within the passage, the first receiving recess being a circular groove, a first connection portion defined in the first end of the first part, an axis of the first connection portion being perpendicular to an axis of the passage, the first connection portion being a rectangular recess and communicating with the passage, the passage and the first connection portion having the same shape and size, a second receiving recess defined radially through the first end of the first part and communicating with the first connection portion, an axis of the first connection portion being perpendicular to an axis of the second receiving recess which is a hole, the axis of the second receiving recess being parallel to an axis of the first receiving recess, a reception hole defined radially in the first end of the first part, the passage having an engaging recess which is a circular recess and communicates with the passage and the reception hole, a second connection portion formed on a second end of the first part and being a rectangular protrusion which is adapted to be connected with a socket, the first part being a rod, the passage, the first connection portion and the second connection portion having the same specification;
a second part unit connected to the first part and having a second part, a first bead, a first resilient member, a second bead, a third bead, a third resilient member and a fourth bead;
the second part being a rod and having a rectangular cross section that is allowed to extend through the passage of the first part, the second part movably extending through the passage and being perpendicular to the first part, the second part having a third connection portion formed on a first end thereof and the third connection portion being a rectangular protrusion which has the same specification as the first connection portion and the second connection portion, the third connection portion having a first recess defined in one side of the second part, the first recess being a circular recess and located corresponding to the first receiving recess of the first part, a diameter of the first recess being the same as a diameter of the engaging recess, a second recess defined next to the first recess which is located closer to the third connection portion than the second recess, the second recess being a circular recess, a diameter of the second recess being smaller than the diameter of the first recess, a fourth connection portion formed on a second end of the second part and being a rectangular protrusion, the fourth connection portion having the same specification as that of the second and third connection portions, a fifth connection portion formed between the second end of the second part and the fourth connection portion, the fifth connection portion having a rectangular cross section and having the same specification as the fourth connection portion, the fourth connection portion having a third recess which is a circular recess, a diameter of the third recess being the same as diameter of the first recess, the fifth connection portion having a fourth recess which is a circular recess, a diameter of the fourth recess being the same as the diameter of the second recess, the fourth recess, the third recess, the second recess and the first recess located on the same side of the second part, the second part having multiple first engaging portions defined in another side thereof and each first engaging portions being a circular recess, one of the first engaging portions located at a middle of the second part, when the second part moves, the engaging recess of the first part is located corresponding to one of the first engaging portions;
the first bead and the first resilient member received in the first recess of the second part, the first resilient member being biased between an inner end of the first recess and the first bead, the first bead received in the first receiving recess so as to be hidden in the first part, the third connection portion located in the first part;
the second bead located in the second recess, a diameter of the second bead being smaller than a diameter of the first bead, the second bead restricting the second part from disengaging from the passage;
the third bead and the third resilient member received in the third recess of the second part, the third resilient member being biased between an inner end of the third recess and the third bead;
the fourth bead located in the fourth recess, a diameter of the fourth bead being the same as the diameter of the second bead, the fourth bead restricting the second part from disengaging from the passage;
a push unit connected to the first part and having a rod, a fifth bead and a fifth resilient member;
the rod movably located in the reception hole and an end of the rod protruding from the reception hole, a notch defined in a lateral side of one end of the rod and including a first position and a second position, the engaging recess located corresponding to the first and second positions of the notch when the rod moves;
the fifth bead located in the engaging recess and the first position of the notch, the fifth bead protruding from the engaging recess and contacting against the first engaging portion of the second part to position the second part;
the fifth resilient member located in the reception hole of the first part, the fifth resilient member biased between the reception hole and the rod, the fifth resilient member being a spring;
a third part unit connected to the first part, the first part, the second part unit and the third part unit arranged to be a cross-shaped combination, the third part unit having a third part, two engaging members and two sixth resilient members;
the third part being a rod and having a rectangular cross section which is the same as the first connection portion of the first part, the third part having a sixth connection portion formed on each of two ends thereof, the sixth connection portions being able to be engaged with the first connection portion of the first part, the sixth connection portion having the same specification as the second, third, fourth and fifth connection portions, the third part having two sixth recesses defined in one side thereof and each sixth recess being a circular recess, the two sixth recesses being alternatively located corresponding to the second receiving recess of the first part, the third part having multiple second engaging portions formed in another side thereof, one of the second engaging portions located at a middle of the third part, each second engaging portion being a circular recess;
the engaging members respectively located in the sixth recesses and partially protruding from the sixth recesses, and
the sixth resilient members respectively located in the sixth recesses of the third part and each being biased between the sixth recess and the engaging member corresponding thereto which contacts the second receiving recess so that the sixth connection portion of the third part is engaged with the first connection portion, the sixth resilient members each being a spring.

2. The cross wrench as claimed in claim 1, wherein the fourth connection portion includes a first face, a second face and a third face, the first face is located between the second and third faces, the second and third faces are located symmetrically relative to the first face, the first face is a curved face, the second and third faces each are an inclined face, the third recess is located corresponding to the first face.

3. The cross wrench as claimed in claim 1, wherein the engaging members each are a stepped cylindrical part.

4. The cross wrench as claimed in claim 1, wherein when the rod is pushed, the rod moves in the reception hole and contacts the fifth resilient member, the fifth bead is received in the second position of the notch so that the fifth bead is disengaged from the first engaging portion and merged in the engaging recess, the second part is not restricted by the push unit and movable relative to the first part so that the second part is adjusted.

5. The cross wrench as claimed in claim 1, wherein the third part unit includes an engaging member and a sixth resilient member, a pin extends through the second receiving recess of the first part and the sixth recess of the third part so that the third part is engaged with the first connection portion, the pin restricts the third part from disengaging from the first connection portion.
